(19) United States
(12) Patent Application Publication
(10) Pub. No.: US 2011/0165344 A1
(43) Pub. Date: Jul. 7, 2011

(54) SURFACE ANTENNA FORMATION METHOD

(76) Inventors: Daniel CHANG, Pa-Te City (TW); Yu-Shu CHAO, Pa-Te City (TW); Chien-Ming LIN, Pa-Te City (TW); Tsung-Han LI, Pa-Te City (TW)

(21) Appl. No.: 12/683,143

(22) Filed: Jan. 6, 2010

(51) Int. Cl. B05D 5/12

(52) U.S. Cl. 427/555; 427/58

(57) ABSTRACT

A surface antenna formation method to form an antenna on the surface of an antenna carrier economically by means of spraying a conducting paint into a patterned opening of a shield being covered on the antenna carrier and then employing a laser etching technique to remove burrs from the border of the antenna thus formed on the surface of the antenna carrier after removal of the shield.

### BACKGROUND OF THE INVENTION

1. Field of the Invention

The present invention relates to the fabrication of a surface antenna and more particularly, to such a surface antenna formation method, which uses a removable slotted shield to cover an antenna carrier for enabling an antenna to be formed on the surface of the antenna carrier by means of spray painting.

2. Description of the Related Art

Following fast development of wireless communication technology, many mobile electronic products, such as cellular telephone, notebook computer, PDA, electronic book and etc. are created to serve people. For receiving and transmitting signals wirelessly, a mobile electronic product must be equipped with an antenna. Regular mobile electronic products commonly use a planar antenna design to fit mobility.

In order to save the space, a planar antenna may be directly formed on a non-conductive surface of the mobile electronic product, for example, the surface of the casing. After painting of a conducting paint onto the non-conductive surface, a laser etching technique is employed to etch the non-conductive surface, thereby forming the desired antenna.

FIGS. (A)˜(D) show the formation of a surface antenna according to the prior art. In FIG. 1(A), an antenna carrier 9 is provided having a surface 91 for the formation of an antenna. In FIG. 1(B), a conducting paint 93 is sprayed onto the whole area of the surface 91 of the antenna carrier 9, forming a metal conducting layer. Thereafter, as shown in FIG. 1(C), a laser etching technique is employed to etch the metal conducting layer, thereby forming an antenna 92 on the surface of the antenna carrier 9.

The above prior art technique is to spray a conducting paint on the whole area of the surface of the antenna carrier and then to etch the metal conductive layer with a laser beam. This method takes much time and wastes much conducting paint, resulting in a high manufacturing cost and low yield rate.

Therefore, it is desirable to provide a surface antenna formation method that eliminates the aforesaid problem.

### SUMMARY OF THE INVENTION

The present invention has been accomplished under the circumstances in view. It is therefore the main object of the present invention to provide a surface antenna formation method, which saves the antenna fabrication time and cost and improves the yield rate.

To achieve this and other objects of the present invention, a surface antenna formation method includes the steps of (a) providing an antenna carrier having a surface; (b) providing a shield adapted for covering the surface of the antenna carrier and then making an opening on the shield subject to the pattern of the surface antenna to be formed on the surface of the antenna carrier; (c) covering the shield on the antenna carrier to have the opening be located on the surface of the antenna carrier; (d) spraying a conducting paint into the opening of the shield by means of spray-painting to have the applied conducting paint be adhered to the surface of the antenna carrier to form an antenna pattern; (e) removing the shield from the antenna carrier; and (f) employing a laser etching technique to remove burrs from the border of the antenna thus formed on the surface of the antenna carrier.

### BRIEF DESCRIPTION OF THE DRAWINGS

FIGS. A˜D illustrate the formation of a surface antenna according to the prior art.

FIG. 2 is a flow chart of a surface antenna formation process according to the present invention.

FIG. 3 is a schematic drawing of an antenna carrier and a shield provided according to the present invention.

FIG. 4 is a schematic drawing showing the performance of a spray-painting technique according to the present invention.

FIG. 5 is a schematic drawing of the present invention, showing a laser etching technique employed to remove burrs from the antenna.

FIG. 5A is an enlarged view of a part of the antenna shown in FIG. 5, where the lower part shows burrs on the border of the antenna before laser etching; the upper part shows a straight edge after laser etching.

FIG. 6 is an elevational view of a finished product made according to the present invention.

### DETAILED DESCRIPTION OF THE PREFERRED EMBODIMENT

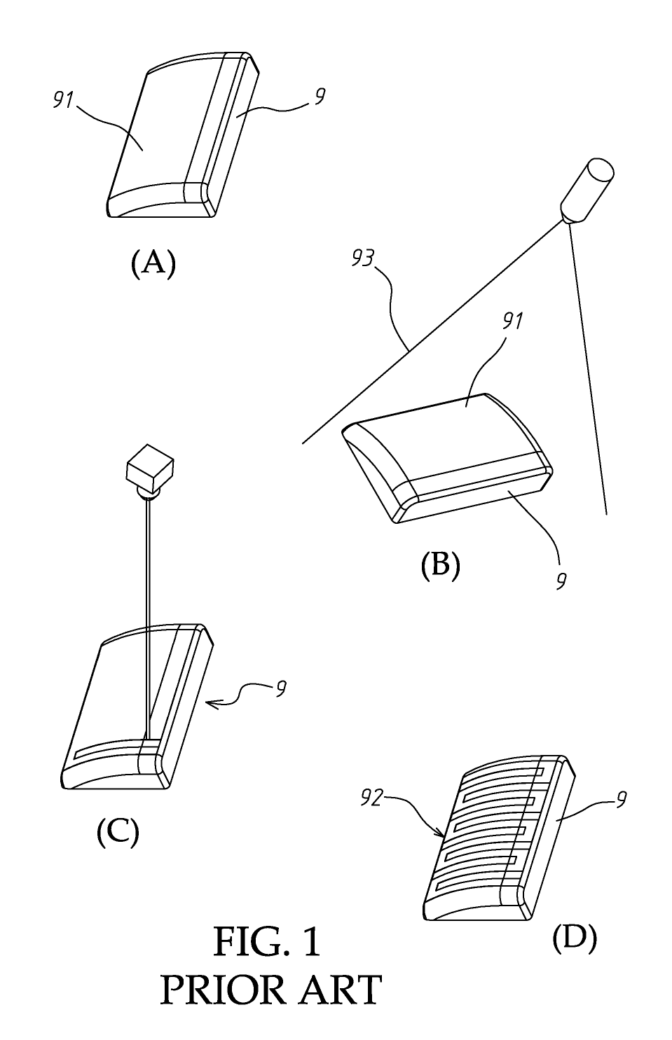

Referring to FIG. 2, a surface antenna formation method in accordance with the present invention is shown comprising the steps of:
(a) providing an antenna carrier having a surface;
(b) providing a shield adapted for covering the surface of the antenna carrier and then making an opening on the shield subject to the pattern of the surface antenna to be formed on the surface of the antenna carrier;
(c) covering the shield on the antenna carrier to have the opening be located on the surface of the antenna carrier;
(d) spraying a conducting paint into the opening of the shield by means of spray-painting to have the applied conducting paint be adhered to the surface of the antenna carrier to form an antenna pattern; and
(e) removing the shield from the antenna carrier.

Further, a laser beam may be employed to remove burrs from the border of the antenna thus formed on the surface of the antenna carrier.

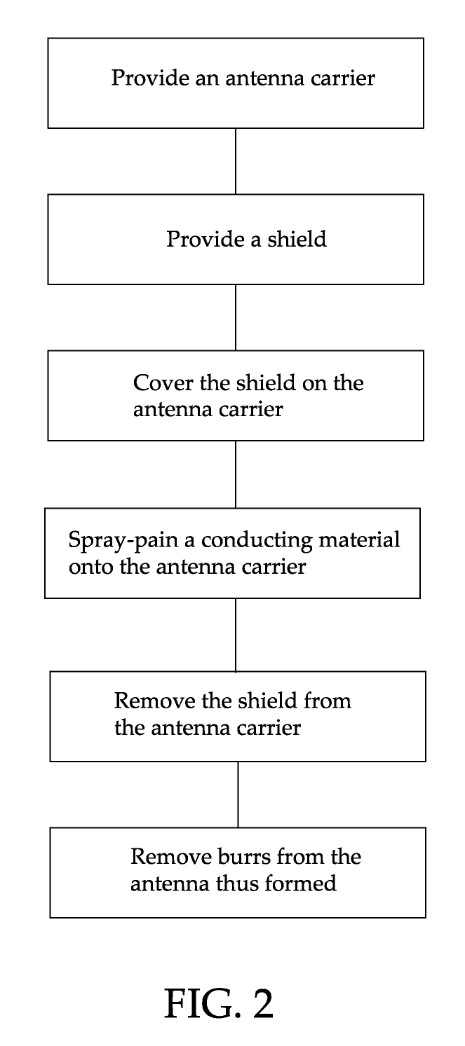

FIGS. 3˜6 illustrate the manufacturing process of the present invention. As shown in FIG. 3, an antenna carrier 1 and a shield 2 are provided. The antenna carrier 1 has a surface 11 for the formation of an antenna. The shield 2 can be covered over the surface 11 of the antenna carrier 1. Further, an opening 21 is formed on the shield 2 subject to the shape of the antenna to be formed on the surface 11 of the antenna carrier 1.

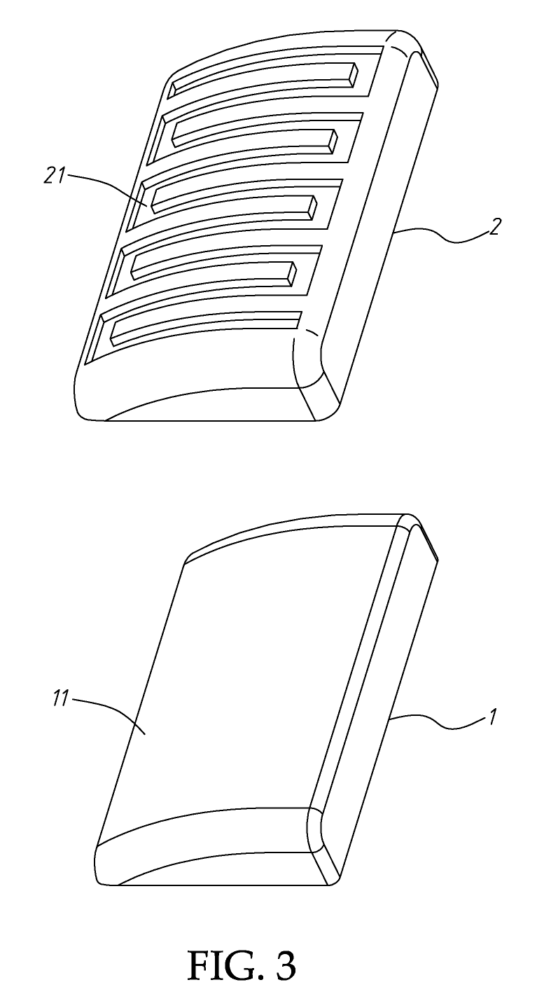

As shown in FIG. 4, the shield 2 is covered on the antenna carrier 1 to have the opening 21 be located on the surface 11 of the antenna carrier 1. Thereafter, spray a conducting paint 3 into the opening 21 of the shield 2 to have the applied conducting paint 3 be adhered to the surface 11 of the antenna carrier 1, thereby forming an antenna pattern on the surface 11 of the antenna carrier 1.

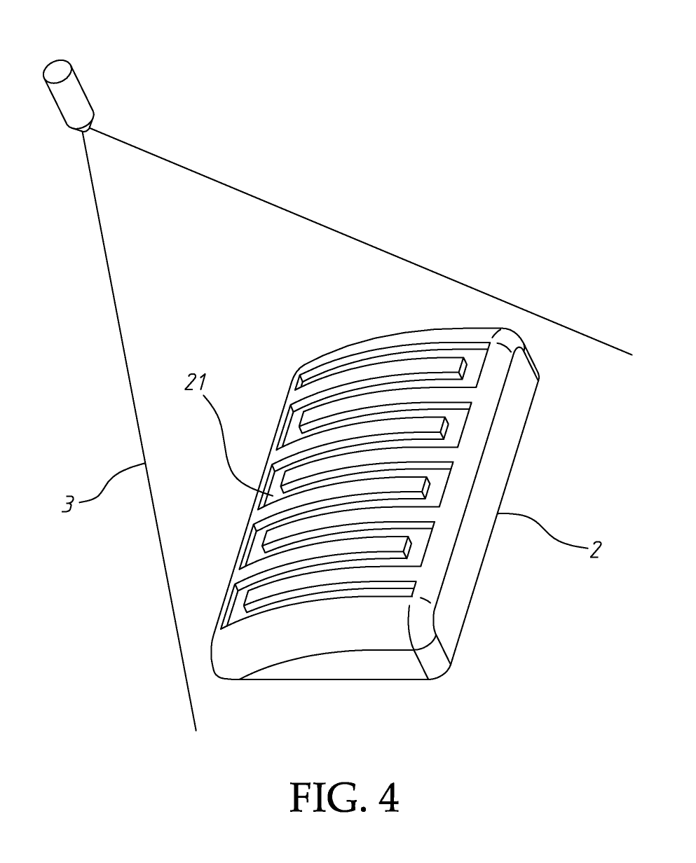

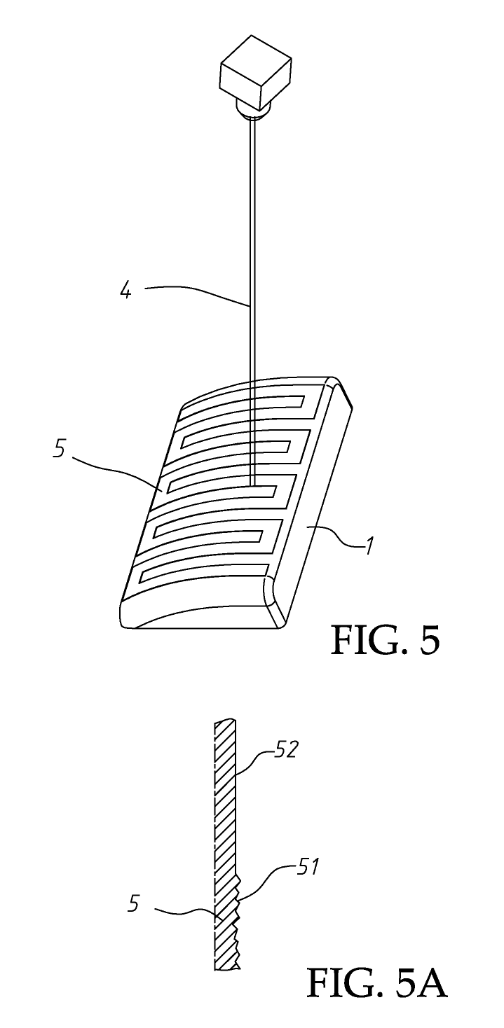

As shown in FIG. 5, the shield 2 is then removed from the antenna carrier 1, and then a laser beam 4 is applied to remove burrs from the border of the antenna 5 thus formed on the surface 11 of the antenna carrier 1. FIG. 5A is an enlarged view of a part of the antenna 5 where the lower part shows burrs 51 on the border of the antenna 5 before laser etching; the upper part shows a straight edge 52 after laser etching.

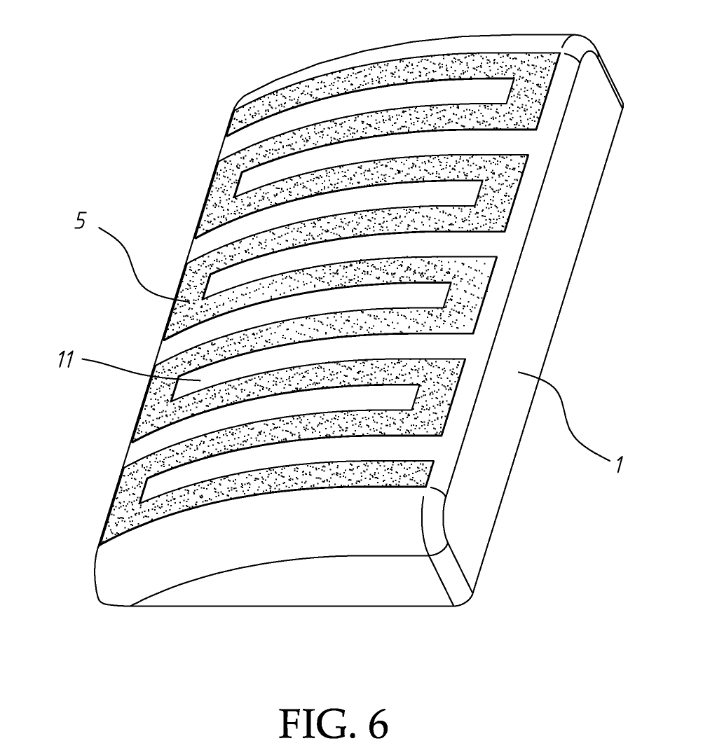

FIG. 6 illustrates the finished product after laser etching, where an antenna 5 is formed on the surface 11 of the antenna carrier 1.

Further, the antenna carrier 1 can be a casing for cellular telephone. Further, the surface 11 of the antenna carrier 1 can be an arched surface.

Subject to the application of the shield 2, it is quite simple to remove burrs 51 from the antenna by means of laser etching. Therefore, the invention greatly saves the surface antenna fabrication time and cost and also improves the yield rate.

Further, a micro drop technique may be employed to apply the conducting paint 3 along the border of the opening 21 of the shield 2 during spray painting, saving conducting paint consumption, and therefore the cost can be relatively reduced.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A surface antenna formation method, comprising the steps of:
(a) providing an antenna carrier having a surface for the formation of an antenna;
(b) providing a shield adapted for covering the surface of said antenna carrier and then making an opening on said shield subject to the pattern of the surface antenna to be formed on the surface of said antenna carrier;
(c) covering said shield on said antenna carrier to have said opening be located on the surface of said antenna carrier;
(d) spraying a conducting paint into the opening of said shield to have the applied conducting paint be adhered to the surface of said antenna carrier to form an antenna pattern; and
(e) removing said shield from said antenna carrier.

2. The surface antenna formation method as claimed in claim 1, further comprising step (f) applying a laser beam to remove burrs from the border of the antenna thus formed on the surface of said antenna carrier.

3. The surface antenna formation method as claimed in claim 1, wherein said antenna carrier is a casing for cellular telephone.

4. The surface antenna formation method as claimed in claim 1, wherein the surface of said antenna carrier is smoothly arched.
